(19) United States
(12) Patent Application Publication
(10) Pub. No.: US 2009/0195478 A1
(43) Pub. Date: Aug. 6, 2009

(54) Low-Profile Antenna

(75) Inventors: Tiao-Hsing Tsai, Yungho City (TW); Chieh-Ping Chiu, Er Lun Hsiang (TW); Chih-Wei Liao, Su-ao Township (TW); Peng-Jen Weng, Kuei Shan Hsiang (TW)

Correspondence Address: BROMBERG & SUNSTEIN LLP, 125 SUMMER STREET, BOSTON, MA, 02110-1618, US

(73) Assignee: Quanta Computer Inc., Kuei Shan Hsiang (TW)

(21) Appl. No.: 12/173,880

(22) Filed: Jul. 16, 2008

(30) Foreign Application Priority Data
Feb. 4, 2008 (TW) 097104199

(51) Int. Cl. H01Q 1/36; H01Q 9/04

(52) U.S. Cl. 343/895; 343/700 MS

(57) ABSTRACT

An antenna includes a dielectric substrate, feeding and grounding elements, a base element, a radiating element, and an interconnecting element. The feeding and grounding elements are formed on the dielectric substrate. The base element is mounted on the dielectric substrate such that the base element is in electrical contact with the feeding and grounding elements. The radiating element is spaced apart from the dielectric substrate. The interconnecting element interconnects the base element and the radiating element.

### CROSS-REFERENCE TO RELATED APPLICATION

This application claims priority of Taiwanese application no. 097104199, filed on Feb. 4, 2008.

### BACKGROUND OF THE INVENTION

1. Field of the Invention

This invention relates to an antenna, more particularly to an antenna operable in a global positioning system (GPS) frequency range.

2. Description of the Related Art

A conventional patch-type global positioning system (GPS) antenna 11, as illustrated in FIG. 1, for a handheld electronic device 100 is well known in the art. The conventional patch-type GPS antenna 11, however, has a relatively large physical size. To solve this problem, it has been proposed to use a GPS antenna that is of the planar inverted-F (PIF) type. As illustrated in FIG. 2, the conventional PIF-type GPS antenna 12 is connected to an electrical ground (not shown) and a transceiver (not shown) of a circuit (not shown) of a handheld electronic device (not shown) formed on a circuit board 15 of the handheld electronic device through a pair of interconnecting members 13, 14, respectively.

Although the conventional PIF-type GPS antenna 12 has a low profile and creates a strong lower lobe in a radiating pattern therefor, the conventional PIF-type GPS antenna 12 has a weak upper lobe in the radiation pattern thereof. That is, the conventional PIF-type GPS antenna 12 has a signal strength that drops off rapidly at a zenith of the upper lobe in the radiation pattern thereof.

### SUMMARY OF THE INVENTION

Therefore, the object of the present invention is to provide an antenna that can overcome the aforesaid drawback of the prior art.

According to the present invention, an antenna comprises a dielectric substrate, spaced apart feeding and grounding elements, a base element, a spiral radiating element, and an interconnecting element. The feeding and grounding elements are formed on the dielectric substrate. The base element is mounted on the dielectric substrate such that the base element is in electrical contact with the feeding and grounding elements. The radiating element is spaced apart from the dielectric substrate. The interconnecting element interconnects the base element and the radiating element.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional patch antenna mounted on a handheld electronic device;

FIG. 2 is a perspective view of a conventional planar inverted-F antenna (PIFA) mounted on a circuit board of a handheld electronic device;

FIG. 3 is a perspective view of the first preferred embodiment of an antenna according to this invention;

FIG. 4 is a perspective view illustrating feeding and grounding elements of the first preferred embodiment;

FIG. 5 is a plot illustrating a voltage standing wave ratio (VSWR) of the first preferred embodiment;

FIG. 6 shows plots of radiation patterns of the first preferred embodiment respectively on the x-y, x-z, and y-z planes when operated at 1575 MHz;

FIG. 7 is a perspective view of the second preferred embodiment of an antenna according to this invention; and

FIGS. 8 to 10 are schematic views illustrating modified embodiments of the second preferred embodiment.

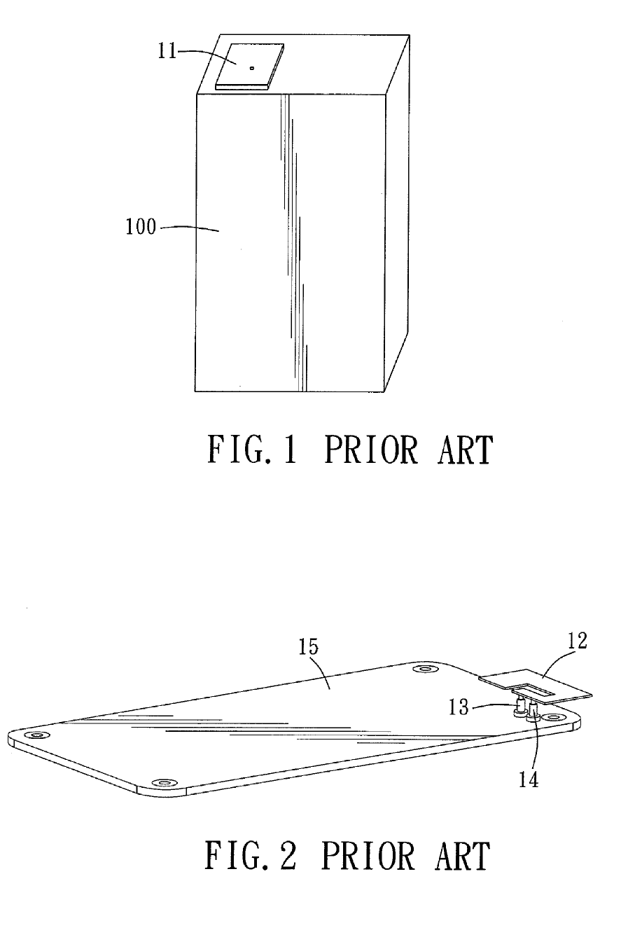

### DETAILED DESCRIPTION OF THE PREFERRED EMBODIMENTS

Before the present invention is described in greater detail, it should be noted that like elements are denoted by the same reference numerals throughout the disclosure.

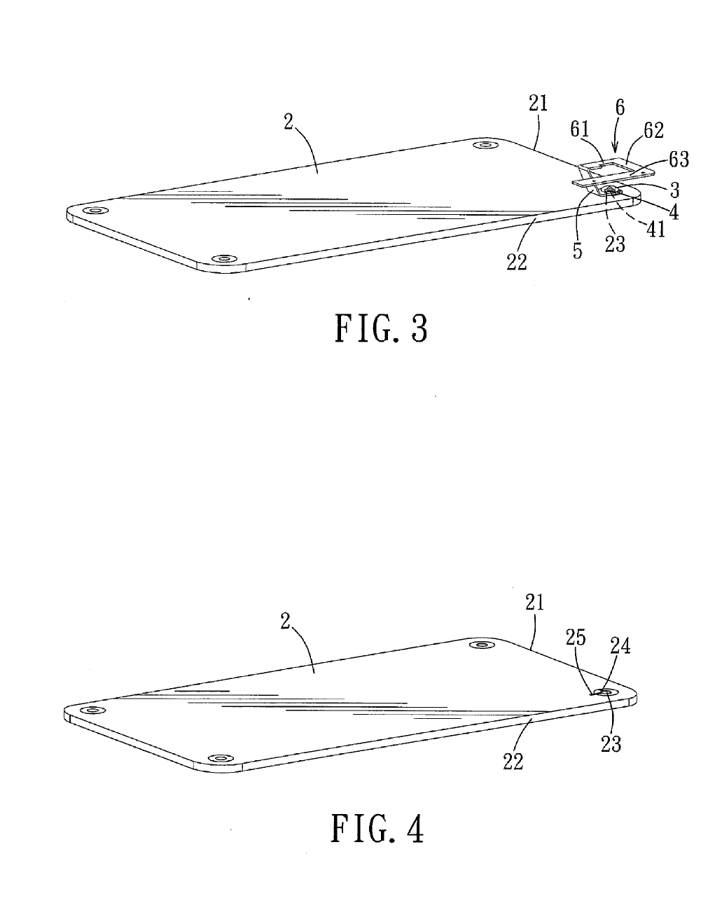

Referring to FIGS. 3 and 4, the first preferred embodiment of an antenna according to this invention is shown to include a dielectric substrate 2, spaced apart feeding and grounding elements 25, 24, a base element 4, a spiral radiating element 6, and an interconnecting element 5.

The antenna of this invention is a planar inverted-F antenna (PIFA), is operable at a carrier wave frequency of 1575.42 MHz and in a global positioning system (GPS) frequency range, i.e., 1575.42±1.023 MHz, and is applicable to a handheld electronic device (not shown), such as a personal digital assistant (PDA) or a smart phone.

The dielectric substrate 2 is generally rectangular in shape, has adjacent first and second edges 21, 22, and is formed with a hole 23 that is disposed proximate to a corner of the first and second edges 21, 22 of the dielectric substrate 2.

It is noted that, in this embodiment, the electronic device includes a circuit (not shown) formed on the dielectric substrate 2.

The feeding element 25 is formed on the dielectric substrate 2, is disposed at a periphery of the hole 23 in the dielectric substrate 2, and is connected electrically to a signal source (not shown) of the circuit of the electronic device.

The grounding element 24 is formed on the dielectric substrate 2, is disposed at the periphery of the hole 23 in the dielectric substrate 2, and is connected electrically to an electrical ground (not shown) of the circuit of the electronic device.

The base element 4 is generally rectangular in shape, and is mounted on the dielectric substrate 2 such that the base element 4 is in electrical contact with the feeding and grounding elements 25, 24. In this embodiment, the base element 4 is mounted removably on the dielectric substrate 2. In particular, the hole 23 in the dielectric substrate 2 is defined by a hole-defining wall formed with an inner thread. The base element 4 is formed with a hole 41 therethrough that is aligned with the hole 23 in the dielectric substrate 2. The antenna further includes a fastening member 3 that fastens detachably the base element 4 to the dielectric substrate 2. In this embodiment, the fastening member 3 is in the form of a screw, extends through the hole 41 in the base element 4 and the hole 23 in the dielectric substrate 2, and is formed with an outer thread that threadedly engages the inner thread of the hole-defining wall of the dielectric substrate 2.

It is noted that the fastening member 3, aside from fastening the base element 4 to the dielectric substrate 2, may be used to fasten the dielectric substrate 2 to the electronic device as well.

The radiating element 6 is spaced apart from the dielectric substrate 2, and has a free end portion that is parallel to and that overlaps the second edge 22 of the dielectric substrate 2. In particular, the radiating element 6 includes first, second, and third radiating portions 61, 62, 63. The first radiating portion 61 has opposite first and second ends. The second radiating portion 62 extends transversely from the first radiating portion 61, is parallel to and overlaps the first edge 21 of the dielectric substrate 2, and has a first end connected to the second end of the first radiating portion 61, and a second end opposite to the first end thereof. The third radiating portion 63 defines the free end portion of the radiating element 6, extends transversely from the second radiating portion 62, and has a first end connected to the second end of the second radiating portion 62, and a second end opposite to the first end thereof.

The construction of the radiating element 6 as such enhances radiation of the antenna of this invention, and thus creates an improved upper lobe in a radiation pattern for the antenna of this invention. Moreover, the second end of the third radiating portion 63 of the radiating element 6 and the circuit of the electronic device cooperatively generate a capacitor load therebetween, thereby increasing an operating frequency bandwidth of the antenna of this invention. Further, since the dielectric substrate 2 is fiat and lies in a first plane and since the radiating element 6 is flat and lies in a second plane parallel to the first plane, the antenna of this invention has a relatively low profile. In addition, the radiating element 6 of the antenna of this invention may be lengthened to lower an operating frequency thereof.

The interconnecting element 5 interconnects the base element 4 and the first end of the first radiating portion 61 of the radiating element 6. In this embodiment, the interconnecting element 5 extends inclinedly with respect to the dielectric substrate 2.

In this embodiment, the radiating element 6 and the interconnecting element 5 have a total length of one-quarter wavelength at the carrier wave frequency, i.e., approximately five centimeters at 1575.42 MHz. Moreover, in this embodiment, the first edge 21 of the dielectric substrate 2 has a length of one-quarter wavelength, i.e., approximately six centimeters. The construction as such enhances reception of the antenna of this embodiment.

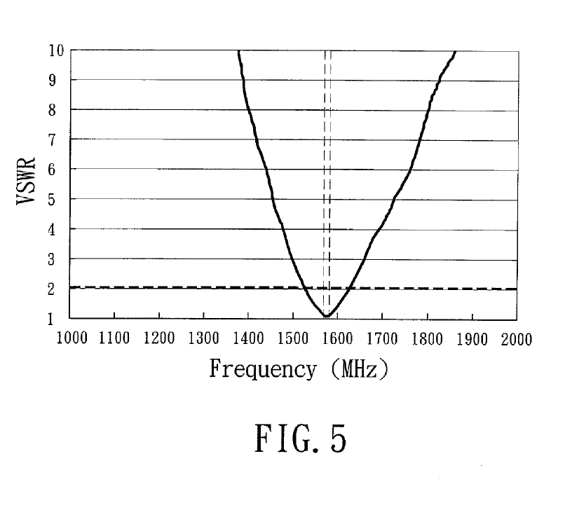

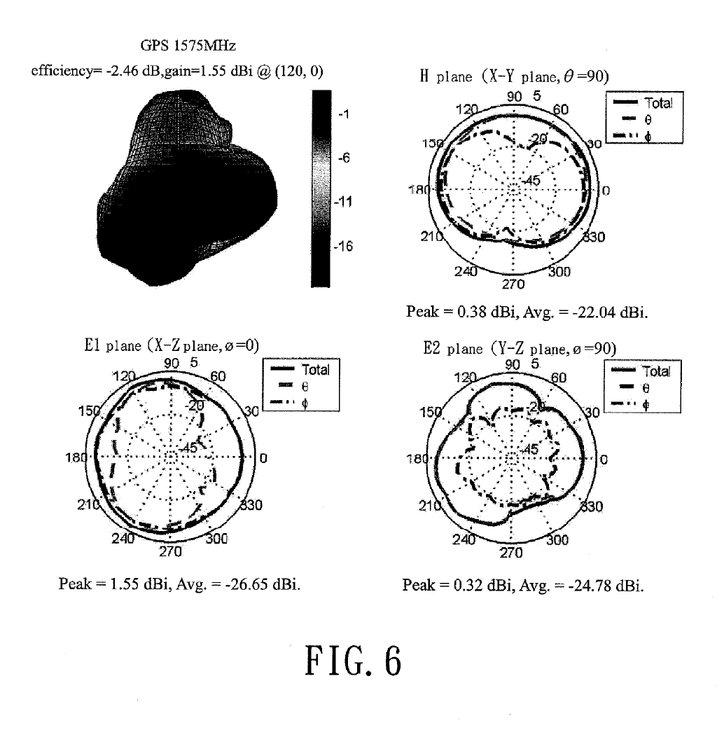

Experimental results, as illustrated in FIG. 5, show that the antenna of this embodiment achieves a voltage standing wave ratio (VSWR) of less than 2.0 when operated in the GPS frequency range. Moreover, as shown in Table I, the antenna of this embodiment has satisfactory efficiencies and gains. Further, as illustrated in FIG. 6, the antenna of this embodiment has substantially omnidirectional radiation patterns when operated at 1575 MHz.

TABLE I

| | Efficiency | | Average Gain |
|---|---|---|---|
| View | (dB) | Gain (dBi) | (dBi) |
| 180 | −2.36 | 1.35 | −2.36 |
| 75 | −8.44 | −1.3 | −4.13 |
| 120 | −3.75 | 1.35 | −2.5 |
| upper lobe | −6.85 | −1.22 | −3.84 |
| lower lobe | −4.27 | 1.35 | −0.58 |

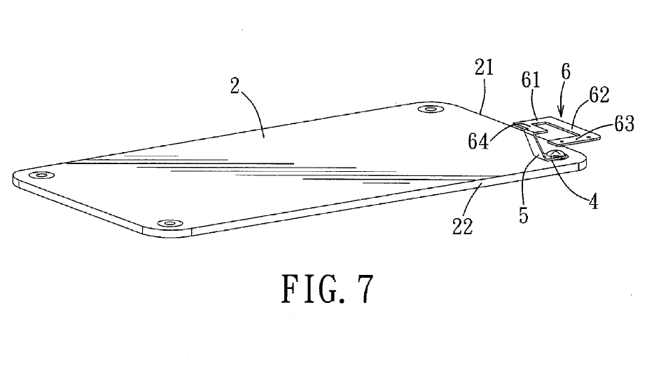

FIG. 7 illustrates the second preferred embodiment of an antenna according to this invention. This embodiment differs from the previous embodiment in that the radiating element 6 further includes a fourth radiating portion 64 that extends transversely from the first radiating portion 61, and that has opposite first and second ends. The first end of the first radiating portion 61 is connected to the second end of the fourth radiating portion 64. The interconnecting element 5 interconnects the base element 4 and the first end of the fourth radiating portion 64 of the radiating element 6.

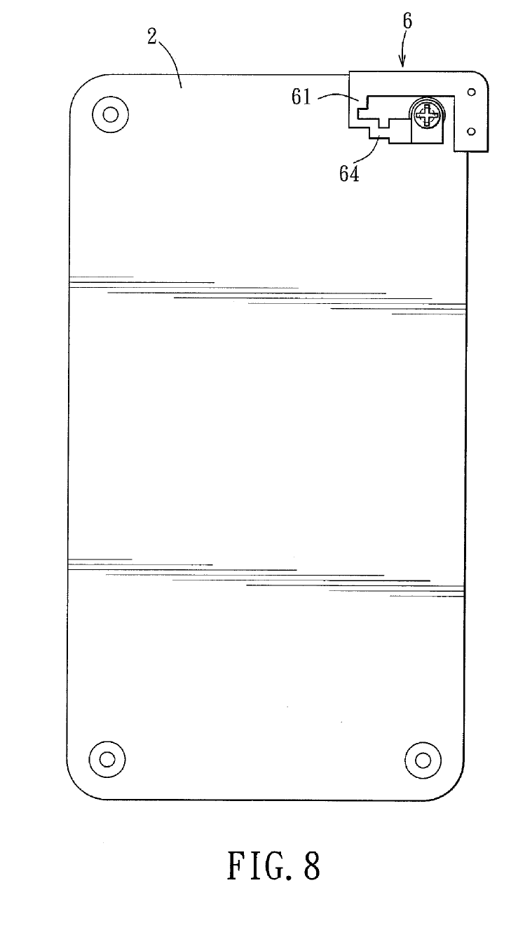

FIG. 8 illustrates a modified embodiment of the second preferred embodiment according to this invention. In this embodiment, each of the first and fourth radiating portions 61, 64 of the radiating element 6 is of the meander line type. As such, the radiating element 6 may be lengthened to thereby lower an operating frequency thereof without increasing the profile of the antenna of this invention.

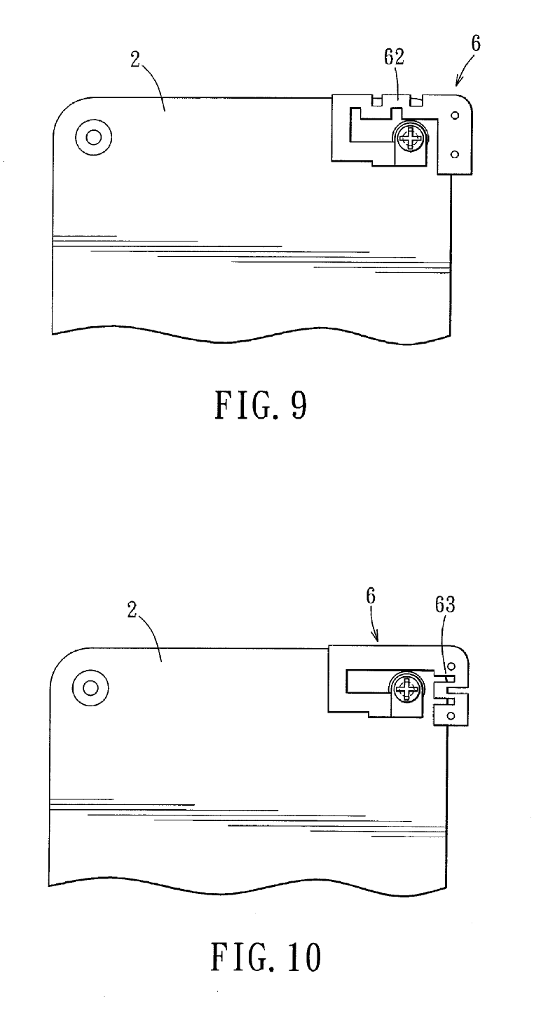

FIG. 9 illustrates another modified embodiment of the second preferred embodiment according to this invention. In this embodiment, the second radiating portion 62 of the radiating element 6 is of the meander line type.

FIG. 10 illustrates yet another modified embodiment of the second preferred embodiment according to this invention. In this embodiment, the third radiating portion 63 of the radiating element 6 is of the meander line type.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An antenna comprising:
a dielectric substrate;
spaced apart feeding and grounding elements formed on said dielectric substrate;
a base element mounted on said dielectric substrate such that said base element is in electrical contact with said feeding and grounding elements;
a spiral radiating element spaced apart from said dielectric substrate; and
an interconnecting element interconnecting said base element and said radiating element.

2. The antenna as claimed in claim 1, wherein said dielectric substrate has an edge, and said radiating element has a free end portion that is parallel to and that overlaps said edge of said dielectric substrate.

3. The antenna as claimed in claim 1, wherein said radiating element includes a first radiating portion, a second radiating portion that extends transversely from said first radiating portion, and a third radiating portion that extends transversely from said second radiating portion,
said interconnecting element interconnecting said base element and said first radiating portion of said radiating element.

4. The antenna as claimed in claim 3, wherein said dielectric substrate has adjacent first and second edges,
said second radiating portion of said radiating element being parallel to and overlapping said first edge of said dielectric substrate,
said third radiating portion of said radiating element being parallel to and overlapping said second edge of said dielectric substrate.

5. The antenna as claimed in claim 1, wherein said radiating element includes a first radiating portion, a second radiating portion that extends transversely from said first radiating portion, a third radiating portion that extends transversely from said second radiating portion, and a fourth radiating portion that extends transversely from said first radiating portion,
said interconnecting element interconnecting said base element and said fourth radiating portion of said radiating element.

6. The antenna as claimed in claim 5, wherein said dielectric substrate has adjacent first and second edges,
said second radiating portion of said radiating element being parallel to and overlapping said first edge of said dielectric substrate,
said third radiating portion of said radiating element being parallel to and overlapping said second edge of said dielectric substrate.

7. The antenna as claimed in claim 5, wherein each of said first and fourth radiating portions of said radiating element is of the meander line type.

8. The antenna as claimed in claim 5, wherein one of said second and third radiating portions of said radiating element is of the meander line type.

9. The antenna as claimed in claim 1, wherein said base element is mounted removably on said dielectric substrate.

10. The antenna as claimed in claim 9, further comprising a fastening member fastening detachably said base element to said dielectric substrate.

11. The antenna as claimed in claim 10, wherein each of said dielectric substrate and said base element is formed with a hole therethrough, and said fastening member extends through said hole in said base element and said hole in said dielectric substrate.

12. The antenna as claimed in claim 11, wherein said hole in said dielectric substrate is defined by a hole-defining wall that is formed with an inner thread, and said fastening member is formed with an outer thread that threadedly engages said inner thread of said hole-defining wall of said dielectric substrate.

13. The antenna as claimed in claim 1, wherein said antenna is operable at a carrier wave frequency of 1575.42 MHz.
